(19) United States
(12) Patent Application Publication
(10) Pub. No.: US 2005/0130625 A1
(43) Pub. Date: Jun. 16, 2005

(54) Apparatus for reporting a fee discount zone in a mobile communication terminal and method for reporting the same

(75) Inventors: Chu Hyun Chong, Seoul (KR); Ill Kwon Park, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CURITEL COMMUNICATIONS, INC.

(21) Appl. No.: 10/979,314

(22) Filed: Nov. 2, 2004

(30) Foreign Application Priority Data
Dec. 10, 2003 (KR) 10-2003-0089467

(51) Int. Cl. H04Q 7/20

(52) U.S. Cl. 455/406

(57) ABSTRACT

Disclosed are an apparatus for reporting a fee discount zone in a mobile communication terminal and a method for reporting the same. The apparatus comprises a memory part for storing a preferred roaming list and preset system information of the fee discount zone; a fee discount zone judging part for judging whether the mobile communication terminal is present in the fee discount zone; an outputting part for reporting whether the mobile communication terminal is present in the fee discount zone or not; and a central processing part for extracting the system identification and the network identification from the preferred roaming list, transferring the extracted system identification and network identification to the fee discount zone judging part and controlling the outputting part according to the judgment information of the discount zone judging part to report to the user whether or not the terminal is present in the fee discount zone.

### CROSS-REFERENCE TO RELATED APPLICATION

The entire disclosure of the Korean Patent Application No. 10-2003-0089467 filed on Dec. 10, 2003 including specification, claims, drawings and summary, is incorporated herein by reference in its entirety.

### BACKGROUND OF THE INVENTION

1. Field of the Invention

The present invention relates to an apparatus for reporting a fee discount zone in a mobile communication terminal and a method for reporting the same, and more particularly to an apparatus for reporting a fee discount zone in a mobile communication terminal which makes a user of the terminal recognize whether or not the terminal is present in the fee discount zone by using system information acquired by the mobile communication terminal and method for reporting the same.

2. Background of the Related Art

Generally, a mobile communication system divides a total service area into a plurality of base stations, each of the base stations consisting of a plurality of cells each of which is a service area of a small scale, and intensively controls a group of the base stations at a mobile exchanger, thereby making it possible to communicate by the terminal while moving among the cells.

Further, the mobile communication terminal has a preferred roaming list (PRL) used when deciding a system. The PRL contains several acquired recording information and system recording information, wherein system identification (SID) showing a business carrier and network identification (NID) showing an exchanger are important information used to apply a differentiated fee by confirming location information of the terminal when the terminal acquires the system.

For example, if a business carrier for which a mobile communication terminal is subscribed is referred to ‘A’ (SID=22) and a discounted fee is applied to the mobile communication terminal in a zone of NID ‘10’, the discounted fee is applied when the mobile communication terminal acquires the SID‘22’/NID‘10’ system.

When the business carrier applies the differentiated fees, the business carrier assesses on the differentiated fees according to a base station on which the mobile communication terminal is registered. However, a user of the terminal cannot correctly know whether or not his mobile communication terminal is present in a zone in which the discounted fee is applied. Therefore, the user cannot help guessing whether or not the terminal is present in the zone in which the discounted fee is applied by a general geographical name.

Therefore, since the user of the prior mobile communication terminal uses the terminal much more when he or she thinks that the terminal is present in the fee discount zone, a problem occurs that much of cost is charged due to a lot of telephone call in a fee non-discount region adjacent to the fee discount zone. Further, there are adverse effects on the business carrier that users of the mobile communication terminal lodge complaints about a differentiated fee intended to maximize a use of service and thus frequently terminate the service contract.

### SUMMARY OF THE INVENTION

Accordingly, the present invention has been made to solve the above-mentioned problems occurring in the prior art. The object of the present invention is to provide an apparatus for reporting whether or not a user of the terminal is present in the fee discount zone to the user who receives a fee discount service in a predetermined area, thereby making the user accurately recognize whether or not he or she is present in the fee discount zone.

Further, another object of the present invention is to provide a method for reporting a fee discount zone in a mobile communication terminal in order to make a user of the terminal accurately recognize whether or not the user is present in the fee discount zone.

In order to accomplish these objects, there is provided an apparatus for reporting a fee discount zone in a mobile communication terminal comprising: a memory part for storing a preferred roaming list (PRL) received when a mobile communication terminal acquires a system, and system information of the fee discount zone consisting of a business carrier number and an exchanger number of a system in a zone set up as the fee discount zone; a fee discount zone judging part for comparing system identification and network identification of the system acquired by the mobile communication terminal with the system information of the fee discount zone stored in the memory part and judging whether the mobile communication terminal is present in the fee discount zone or not; an outputting part for reporting to a user of the terminal whether the mobile communication terminal is present in the fee discount zone or not; and a central processing part for extracting the system identification and the network identification from the PRL stored in the memory part, transferring the extracted system identification and network identification to the fee discount zone judging part and controlling the outputting part according to the judgment information of the discount zone judging part to report whether or not the terminal is present in the fee discount zone for making the user recognize it.

When the terminal acquires the system information, the central processing part makes the outputting part report to the user that he or she is present in the fee discount zone if a fee discount zone judging signal is transmitted from the fee discount zone judging part, or that the user is present in a fee non-discount zone if a fee non-discount zone judging signal is transmitted from the fee discount zone judging part.

When a transmitting event is produced in the mobile communication terminal, if a fee discount zone judging signal is transferred from the fee discount zone judging part, the central processing part executes a transmitting process corresponding to the transmitting event and thus provides the user with a service to which a fee discount is applied.

When a transmitting event is produced in the mobile communication terminal, if a fee non-discount zone judging signal is transferred from the fee discount zone judging part, the central processing part confirms whether or not the user wants to proceed with a transmitting process corresponding to the transmitting event. When the user does not want to proceed with the transmitting process, the central processing part terminates the transmitting process and then transits to an idle state. On the contrary, when the user wants to proceed with the transmitting process, the central processing part executes the transmitting process and then provides the user with a service to which a fee discount is not applied.

The outputting part may report whether or not the mobile communication terminal is present in the fee discount zone with letters or icons through a LCD screen of the terminal, according to a control of the central processing part. Alternatively, the outputting part may report whether or not the terminal is present in the fee discount zone with voice or acoustic through a speaker or with on and off of a LED.

In order to accomplish the above objects, according to another embodiment of the invention, there is provided a method for reporting a fee discount zone in a mobile communication terminal comprising steps of: acquiring a system by the mobile communication terminal; storing a preferred roaming list in a memory part of the mobile communication terminal; extracting system identification and network identification from the preferred roaming list; comparing the extracted system identification and network identification with preset system information of the fee discount zone stored in the memory part, thereby judging whether the extracted system identification and network identification are included in the system information of the fee discount zone or not; and reporting to a user of the mobile communication terminal that the terminal is present in the fee discount zone through an outputting part of the terminal if it is judged that the extracted system identification and network identification are included in the system information of the fee discount zone, or reporting to the user of the mobile communication terminal that the terminal is present in a fee non-discount zone through the outputting part of the terminal if it is judged that the extracted system identification and network identification are not included in the system information of the fee discount zone.

According to another embodiment of the invention, there is provided a method for reporting a fee discount zone in a mobile communication terminal comprising steps of: producing a transmitting event under an idle state in which a mobile communication terminal is registered on a system; extracting system identification and network identification from a preferred roaming list stored in a memory part of the mobile communication terminal; comparing the extracted system identification and network identification with preset system information of the fee discount zone stored in the memory part, thereby judging whether or not the extracted system identification and network identification are included in the system information of the fee discount zone; and executing a transmitting process and thus providing a user of the terminal with a service to which a fee discount is applied if it is judged that the extracted system identification and network identification are included in the system information of the fee discount zone, or reporting to the user that the terminal is present in a fee non-discount zone through a outputting part of the terminal if it is judged that the extracted system identification and network identification are not included in the system information of the fee discount zone.

Preferably, if it is judged that the extracted system identification and network identification are not included in the system information of the fee discount zone, the method may further comprise steps of: confirming whether the user wants to proceed with the transmitting process after reporting to the user that the terminal is present in the fee non-discount zone through the outputting part of the terminal; and terminating the transmitting process and transiting to the idle state when it is confirmed that the user does not want to continue the transmitting process, or executing the transmitting process and thus providing the user with the service to which the fee discount is not applied when it is confirmed that the user wants to continue the transmitting process.

According to the method, the system information of the fee discount zone may consist of a business carrier number and a exchanger number of a system in a zone set up as the fee discount zone.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing an apparatus for reporting a fee discount zone in a mobile communication terminal according to the present invention;

FIG. 2 is a view showing an example of a table-structure of a preferred roaming list;

FIG. 3 is a flowchart showing a method for reporting a fee discount zone in a mobile communication terminal according to the present invention when a system is acquired; and

FIG. 4 is a flow chart showing a method for reporting a fee discount zone in a mobile communication terminal according to the present invention, when a transmitting event is produced.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

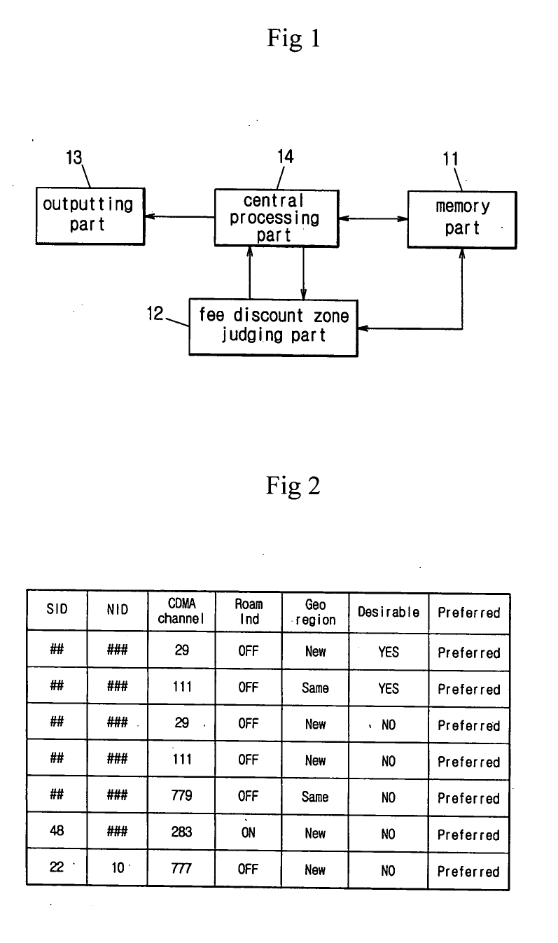

FIG. 1 is a block diagram showing an apparatus for reporting a fee discount zone in a mobile communication terminal according to the present invention. As shown in FIG. 1, the apparatus for reporting the fee discount zone according to the present invention comprises a memory part 11, a fee discount zone judging part 12, an outputting part 13 and a central processing part 14.

The memory part 11 stores a preferred roaming list (PRL) transmitted from a base station when the mobile communication terminal acquires a system. The memory part 11 also stores system information of a fee discount zone consisting of a business carrier number and an exchanger number of a system in a zone set up as the fee discount zone.

The PRL has, for example, a table-structure as shown in FIG. 2. Referring to FIG. 2, system identification (SID) shows a business carrier number, and network identification (NID) shows an exchanger number. A CDMA channel means a frequency band assigned to each of the business carriers, and a roam indicator (Roam Ind) indicates whether the system is a system (i.e., home) of a business carrier for which the terminal is subscribed or a roaming system (i.e., roam) for which the terminal is not subscribed. If the system is a home, the roam indicator becomes off, and if the system is a roam, the roam indicator becomes on.

The fee discount zone judging part 12 compares the SID and the NID of the system acquired by the terminal, which are transmitted from the central processing part 14, with the system information of the fee discount zone preset in the memory part 11, judges whether the terminal is present in the fee discount zone or not, and then transfers the judgment result to the central processing part 14.

The outputting part 13 reports to a user of the terminal whether or not the terminal is present in the fee discount zone according to a control of the central processing part 14 for making the user recognize it. The outputting part 13 can report whether or not the terminal is present in the fee discount zone with letters or icons through a LCD screen of the terminal, voice or acoustics through a speaker or on and off of a LED.

When the terminal acquires a system or a transmitting event is produced, the central processing part 14 extracts the SID and the NID from the PRL stored in the memory part 11 for confirming whether or not the terminal is present in the fee discount zone, transfers the extracted SID and NID to the fee discount zone judging part 12, and then controls the outputting part 13 according to the judgment information of the fee discount zone of the fee discount zone judging part 12 to report whether or not the terminal is present in the fee discount zone for making the user recognize it.

A method for reporting a fee discount zone in the mobile communication terminal having the above-mentioned constitution may be divided into a case of reporting whether a zone is the fee discount zone or not when the terminal acquires a system and a case of reporting whether a zone is the fee discount zone or not when a transmitting event is produced.

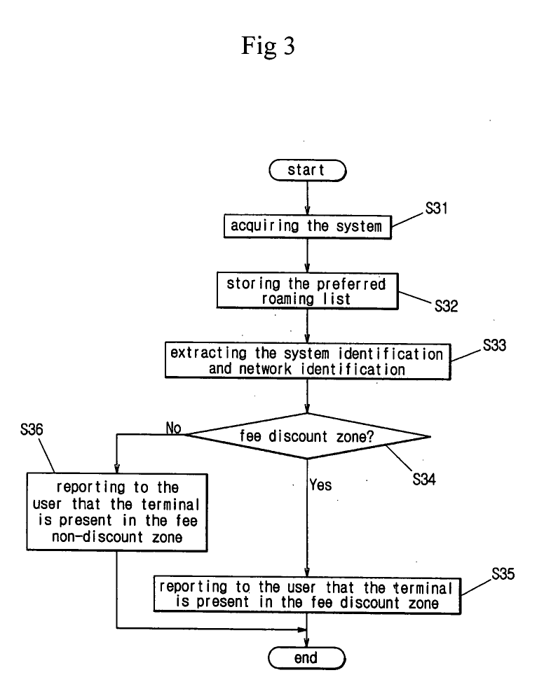

FIG. 3 is a flow chart showing a method for reporting the fee discount zone when the terminal acquires a system. The mobile communication terminal executes a system searching process for acquiring the system when the terminal is turned on or when the terminal is disconnected from the base station.

Then, the terminal acquires a communicable system by executing the system searching process (step S31). At this time, the central processing part 14 receives several system-parameters such as channel information, geography information (GEO), SID, NID and etc., and a PRL as shown in FIG. 2 from the base station. The PRL received from the base station is stored in the memory part 11 (step S32).

Then, the central processing part 14 fetches the PRL stored in the memory part 11 for reporting to the user whether or not the terminal is present in the fee discount zone as the terminal acquires the system information. After that, it extracts the SID and the NID from the PRL, and then transfers them to the fee discount zone judging part 12 (step S33).

Then, the fee discount zone judging part 12 compares the SID and the NID of the system acquired by the terminal, which are transferred from the central processing part 14, with the preset system information of the fee discount zone stored in the memory part 11, and then judges whether the terminal is present in the fee discount zone or not (step S34).

At this time, if it is judged that the terminal is present in the fee discount zone, that is, the SID and the NID acquired by the terminal are included in the preset system information of the fee discount zone, the fee discount zone judging part 12 transfers a fee discount zone judging signal indicating that the terminal is present in the fee discount zone to the central processing part 14.

Then, as the fee discount zone judging signal is transferred from the discount zone judging part 12, the central processing part 14 controls the outputting part 13 to report to the user that the terminal is present in the fee discount zone (step 35). At this time, for example, the contents of “this terminal is present in the fee discount zone” may be reported with letters through a LCD screen of the terminal, voice through a speaker, specified acoustics or on and off of a LED.

If it is judged in the step of S34 that the terminal is not present in the fee discount zone, that is, the SID and the NID acquired by the terminal are not included in the preset system information of the fee discount zone, the fee discount zone judging part 12 transfers a fee non-discount zone judging signal indicating that the terminal is not present in the fee discount zone to the central processing part 14.

Then, as the fee non-discount zone judging signal is transferred from the fee discount zone judging part 12, the central processing part controls the outputting part 13 to report to the user that the terminal is present in the fee non-discount zone (step S36). At this time, for example, the contents of “this terminal is present in the fee non-discount zone” may be reported with letters through a LCD screen of the terminal, voice through a speaker, specified acoustics or on and off of a LED. As such, the user of the terminal can exactly recognize whether he or she is present in the fee discount zone or not.

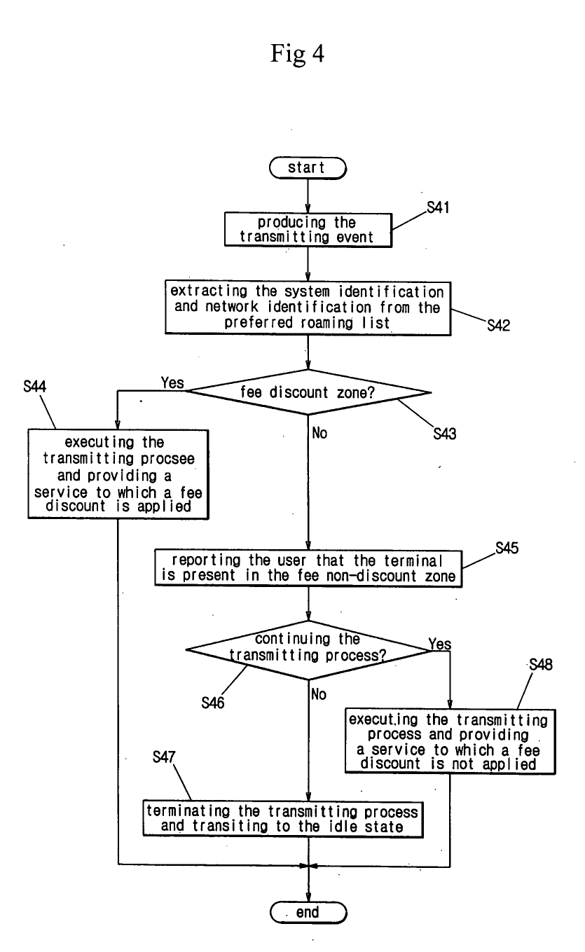

FIG. 4 is a flow chart showing a method for reporting a fee discount zone in the mobile communication terminal when a transmitting event is produced. When a transmitting event is produced as the user tries to call up or to connect with an Internet and etc. with a key operation under an idle state in which the terminal is registered on any base station (step S41), the central processing part 14 fetches the PRL stored in the memory part 11, extracts the SID and the NID from the PRL, and then transfers them to the fee discount zone judging part 12 in order to report to the user whether the terminal is present in the fee discount zone or not (step S42).

Then, the fee discount zone judging part 12 compares the SID and the NID of the system acquired by the terminal, which are transferred from the central processing part 14, with the preset system information of the fee discount zone stored in the memory part 11, and judges whether the terminal is present in the fee discount zone or not (step S43).

At this time, if it is judged that the terminal is present in the fee discount zone, that is, the SID and the NID acquired by the terminal are included in the preset system information of the fee discount zone, the fee discount zone judging part 12 transfers a fee discount zone judging signal indicating that the terminal is present in the fee discount zone to the central processing part 14.

Then, as the fee discount zone judging signal is transferred from the fee discount zone judging part 12, the central processing part 14 performs a transmitting process which is tried by the user, such as a calling-up or an internet connection, etc., thereby providing the user with a service to which a fee discount is applied (step S44).

However, in the step of S43, if it is judged that the terminal is not present in the fee discount zone, that is, the SID and the NID acquired by the terminal are not included in the preset system information of the fee discount zone, the fee discount zone judging part 12 transfers a fee non-discount zone judging signal indicating that the terminal is not present in the fee discount zone to the central processing part 14.

Then, as the fee non-discount zone judging signal is transferred from the fee discount zone judging part 12, the central processing part 14 controls the outputting part 13 to report to the user that the terminal is present in the fee non-discount zone with a LCD screen of the terminal, voices through a speaker, specified acoustics or on and off of a LED, etc. (step S45), and confirms whether the user wants to continue the transmitting process or not in spite that the terminal is present in the fee non-discount zone (step S46).

At this time, when it is confirmed that the user does not want to proceed with the transmitting process, i.e., that the user does not want to use a service in the fee non-discount zone, the central processing part 14 terminates the transmitting process such as a calling-up and an internet connection and then transits to the idle state (step S47).

However, when it is confirmed that the user wants to continue the transmitting process in the fee non-discount zone, i.e., that the user wants to use a service in the fee non-discount zone, the central processing part 14 performs the transmitting process which is tried by the user, such as a calling-up or an internet connection, etc., thereby providing the user with a service to which a fee non-discount is applied (step S48).

As explained above, according to an apparatus for reporting a fee discount zone in the mobile communication terminal and a method for reporting the same, it is reported whether the terminal is present in the fee discount zone or not, so that the user can accurately recognize whether he or she is present in the fee discount zone or not.

Further, according to the present invention, since the user of the mobile communication terminal can accurately recognize whether he or she is present in the fee discount zone or not, it is prevented that the user uses a communicating service in the fee non-discount zone due to a misunderstanding the fee non-discount zone as a fee discount zone. Accordingly, an effective use of a communicating service is induced and a quality of a service is also improved.

While the invention has been shown and described with reference to certain preferred embodiments thereof, it will be understood by those skilled in the art that various changes in form and details may be made therein without departing from the spirit and scope of the invention as defined by the appended claims.

1. An apparatus for reporting a fee discount zone in a mobile communication terminal comprising:
a memory part for storing a preferred roaming list (PRL) received when a mobile communication terminal acquires a system, and system information of the fee discount zone consisting of a business carrier number and an exchanger number of a system in a zone set up as the fee discount zone;
a fee discount zone judging part for comparing system identification and network identification of the system acquired by the mobile communication terminal with the system information of the fee discount zone stored in the memory part and judging whether the mobile communication terminal is present in the fee discount zone or not;
an outputting part for reporting to a user of the terminal whether the mobile communication terminal is present in the fee discount zone or not; and
a central processing part for extracting the system identification and the network identification from the PRL stored in the memory part, transferring the extracted system identification and network identification to the fee discount zone judging part and controlling the outputting part according to the judgment information of the discount zone judging part to report whether or not the terminal is present in the fee discount zone for making the user recognize it.

2. The apparatus according to claim 1, wherein when the terminal acquires the system information, the central processing part makes the outputting part report to the user that he or she is present in the fee discount zone if a fee discount zone judging signal is transmitted from the fee discount zone judging part, or that the user is present in a fee non-discount zone if a fee non-discount zone judging signal is transmitted from the fee discount zone judging part.

3. The apparatus according to claim 1, wherein when a transmitting event is produced in the mobile communication terminal, if a fee discount zone judging signal is transferred from the fee discount zone judging part, the central processing part executes a transmitting process corresponding to the transmitting event and thus provides the user with a service to which a fee discount is applied.

4. The apparatus according to claim 1, wherein when a transmitting event is produced in the mobile communication terminal, if a fee non-discount zone judging signal is transferred from the fee discount zone judging part, after the central processing part confirms whether or not the user wants to proceed with a transmitting process corresponding to the transmitting event, the central processing part terminates the transmitting process and then transits to an idle state when the user does not want to proceed with the transmitting process, or executes the transmitting process and then provides the user with a service to which a fee discount is not applied when the user wants to proceed with the transmitting process.

5. The apparatus according to claim 1, wherein the outputting part reports whether or not the mobile communication terminal is present in the fee discount zone with letters or icons through a LCD screen of the terminal, according to a control of the central processing part.

6. The apparatus according to claim 1, wherein the outputting part reports whether or not the mobile communication terminal is present in the fee discount zone with voice or acoustics through a speaker, according to a control of the central processing part.

7. The apparatus according to claim 1, wherein the outputting part reports whether or not the mobile communication terminal is present in the fee discount zone with on and off of a LED, according to a control of the central processing part.

8. A method for reporting a fee discount zone in a mobile communication terminal comprising steps of:
acquiring a system by the mobile communication terminal;
storing a preferred roaming list in a memory part of the mobile communication terminal;
extracting system identification and network identification from the preferred roaming list;
comparing the extracted system identification and network identification with preset system information of the fee discount zone stored in the memory part, thereby judging whether the extracted system identification and network identification are included in the system information of the fee discount zone or not; and
reporting to a user of the mobile communication terminal that the terminal is present in the fee discount zone through an outputting part of the terminal if it is judged that the extracted system identification and network identification are included in the system information of the fee discount zone, or reporting to the user of the mobile communication terminal that the terminal is present in a fee non-discount zone through the outputting part of the terminal if it is judged that the extracted system identification and network identification are not included in the system information of the fee discount zone.

9. The method according to claim 8, wherein the system information of the fee discount zone consists of a business carrier number and an exchanger number of a system in a zone set up as the fee discount zone.

10. A method for reporting a fee discount zone in a mobile communication terminal comprising steps of:
producing a transmitting event under an idle state in which a mobile communication terminal is registered on a system;
extracting system identification and network identification from a preferred roaming list stored in a memory part of the mobile communication terminal;
comparing the extracted system identification and network identification with preset system information of the fee discount zone stored in the memory part, thereby judging whether or not the extracted system identification and network identification are included in the system information of the fee discount zone; and
executing a transmitting process and thus providing a user of the terminal with a service to which a fee discount is applied if it is judged that the extracted system identification and network identification are included in the system information of the fee discount zone, or reporting to the user that the terminal is present in a fee non-discount zone through a outputting part of the terminal if it is judged that the extracted system identification and network identification are not included in the system information of the fee discount zone.

11. The method according to claim 10, wherein if the extracted system identification and network identification are not included in the system information of the fee discount zone, the method further comprising steps of:
confirming whether the user wants to proceed with the transmitting process after reporting to the user that the terminal is present in the fee non-discount zone through the outputting part of the terminal; and
terminating the transmitting process and transiting to the idle state when it is confirmed that the user does not want to continue the transmitting process, or executing the transmitting process and thus providing the user with the service to which the fee discount is not applied when it is confirmed that the user wants to continue the transmitting process.

12. The method according to claim 10, the system information of the fee discount zone consists of a business carrier number and an exchanger number of a system in a zone set up as the fee discount zone.
